(19) United States
(12) Patent Application Publication
(10) Pub. No.: US 2011/0117970 A1
(43) Pub. Date: May 19, 2011

(54) Mobile device and method for touch lock control based on motion sensing

(75) Inventor: Young Jae Choi, Suwon-si (KR)

(73) Assignee: Samsung Electronics Co., Ltd., Suwon-si (KR)

(21) Appl. No.: 12/927,071

(22) Filed: Nov. 5, 2010

(30) Foreign Application Priority Data
Nov. 19, 2009 (KR) 10-2009-0112032

(51) Int. Cl. H04W 88/02; G06F 3/041

(52) U.S. Cl. 455/566; 345/173

(57) ABSTRACT

A mobile device and a method control a touch lock function to be set in a locked or unlocked stated by sensing motions of the mobile device. When a motion sensor unit detects any motion of the mobile device and creates a sensing signal corresponding to the motion, a control unit of the mobile device sets a touch lock function to a locked state or an unlocked state, depending on the sensing signal. In the locked state of the touch lock function, the control unit does not perform a particular operation assigned to a touch event even though the touch event is generated on a touch panel in response to a user's touch action.

### CROSS-REFERENCE TO RELATED APPLICATION(S) AND CLAIM OF PRIORITY

The present application claims the benefit under 35 U.S.C. §119(a) to a Korean patent application filed in the Korean Intellectual Property Office on Nov. 19, 2009 and assigned Serial No. 10-2009-0112032, the entire disclosure of which is hereby incorporated by reference.

### TECHNICAL FIELD OF THE INVENTION

The present invention relates in general to a mobile device and, more particularly, to a touch lock control based on motions of the mobile device.

### BACKGROUND OF THE INVENTION

With a remarkable growth of related technologies, a great variety of mobile devices are increasing in popularity these days. Particularly, mobile devices today have outgrown their respective traditional fields and have reached a mobile convergence stage.

Nowadays a touch-sensitive device which has a touch screen capable of performing both a display unit and an input unit steadily arouses customers' interests. Normally such a touch-sensitive device employs a touch panel which is attached onto a display screen, offering a touch-based input interface to a user of the device. However, the mobile device that includes the touch screen may often react to unintentional touches and then perform undesired functions.

In order to solve the above problem, a conventional mobile device that includes the touch screen may have a touch lock key (or referred to as a hold key) that a user may press to perform a lock function for a touch input. If a user desires to use the locked touch-based input interface of the touch screen, the touch lock function must first be cancelled. Namely, in order to cancel the touch lock function, a user may usually experience inconvenience caused by having to find a specific touch lock key among many input keys and then to press the touch lock key.

### SUMMARY OF THE INVENTION

To address the above-discussed deficiencies of the prior art, it is a primary object to provide a mobile device and method for controlling a touch lock function to be set to a locked or unlocked state by sensing motions of the mobile device.

According to one aspect of the present invention, provided is a mobile device that includes a motion sensor unit configured to detect a motion of the mobile device and then create a sensing signal corresponding to the motion. A touch panel is configured to generate a touch event in response to a user's touch action. The mobile device also includes a control unit that is configured to set a touch lock function to a locked state or an unlocked state, depending on the sensing signal of the motion sensor unit, wherein during the locked state of the touch lock function, the control unit does not perform a particular operation assigned to the touch event even though the touch event is generated on the touch panel.

According to another aspect of the present invention, provided is a method for controlling a touch lock function in a mobile device. The method includes creating a sensing signal corresponding to a motion of the mobile device by a motion sensor unit. The touch lock function is set to a locked state or an unlocked state, depending on the sensing signal received from the motion sensor unit, wherein during the locked state of the touch lock function, a particular operation assigned to a touch event is not performed even though the touch event is generated on a touch panel.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a mobile device in accordance with an embodiment of the present invention.

FIG. 2 illustrates a process for controlling a touch lock function in a mobile device in accordance with an embodiment of the present invention.

FIG. 3 illustrates a process for controlling a touch lock mode in a mobile device in accordance with an embodiment of the present invention.

### DETAILED DESCRIPTION OF THE INVENTION

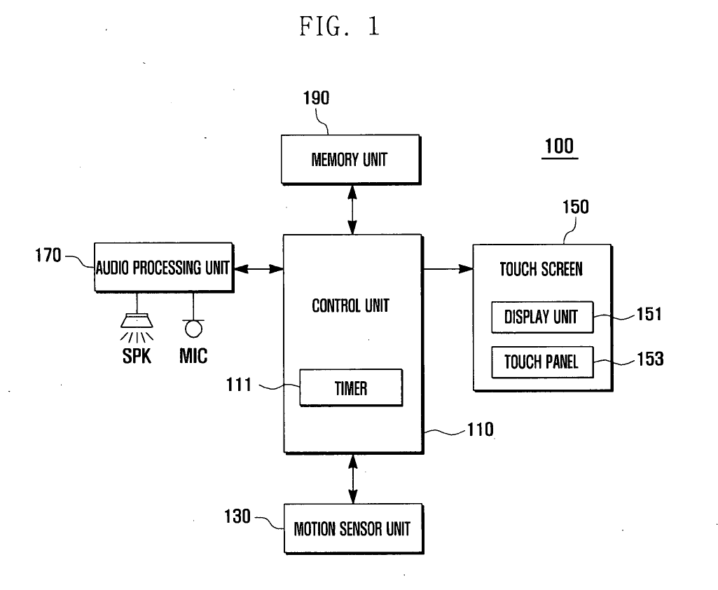

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged mobile device. This invention may, however, be embodied in many different forms and should not be construed as limited to the embodiments set forth herein. Rather, the disclosed embodiments are provided such that this disclosure will be thorough and complete, and will fully convey the scope of the invention to those skilled in the art. The principles and features of this invention may be employed in various and numerous embodiments without departing from the scope of the invention.

Furthermore, well known or widely used techniques, elements, structures, and processes may not be described or illustrated in detail to avoid obscuring the essence of the present invention. Although the drawings represent embodiments of the invention, the drawings are not necessarily to scale, and certain features may be exaggerated or omitted in order to better illustrate and explain the present invention.

Two similar but distinguishable terms, a “touch lock function” and a “touch lock mode”, will be used hereinafter. The touch lock function refers to a function by which a particular operation assigned to a specific touch event may not be performed according to a setting state even though such a touch event is generated on a touch panel of a mobile device. The touch lock function may be in two types of setting states, namely a locked state and an unlocked state. When the touch lock function is set in the locked state, the control unit of the mobile device does not perform a prearranged operation in response to a touch event. Alternatively, in the unlocked state, the control unit performs the prearranged operation in response to a touch event. In particular, the control unit according to this invention can change the setting state of the touch lock function, depending on motions of the mobile device detected by a motion sensor unit.

In contrast, the touch lock mode refers to a specific mode of the mobile device in which the above-discussed touch lock function is performed. When the mobile device enters the touch lock mode, the control unit enables the touch lock function. Alternatively, when the mobile device exits from the touch lock mode, the control unit disables the touch lock function. For instance, any application based on the motion sensor unit often requires that the touch lock function should be disabled. Therefore, the touch lock mode is normally needed for such circumstances.

FIG. 1 illustrates a mobile device in accordance with an embodiment of the present invention.

Referring to FIG. 1, the mobile device 100 includes a motion sensor unit 130, a touch screen 150, an audio processing unit 170, a memory unit 190, and a control unit 110.

In short, the mobile device 100 may set the touch lock function to a locked or unlocked state, depending on its motion detected by the motion sensor unit 130. Now, each individual element of the mobile device 100 will be described in detail.

The motion sensor unit 130 may be implemented with at least one motion sensor (not shown) that detects motions of the mobile device 100 and then transforms the detection into an electrical signal. The motion sensor may include an acceleration sensor, a gyro sensor, a terrestrial magnetic sensor, and such. When the mobile device 100 moves at a certain speed and in a certain direction, the motion sensor unit 130 reacts to motions of the mobile device 100. Specifically, the motion sensor unit 130 measures proper acceleration of the motion by detecting the magnitude and direction of the acceleration as a vector quantity. Then the motion sensor unit 130 creates a sensing signal and sends it to the control unit 110.

The touch screen 150 performs both an output function and an input function of the mobile device 100. Namely, the touch screen 150 includes a display unit 151 and a touch panel 153. The display unit 151 displays a variety of information on a screen in association with the operation of the mobile device 100. For example, the display unit 151 may output a booting screen, an idle screen, a menu screen, and any other predefined screens in connection with the execution of a selected application. The display unit 151 may be formed of a liquid crystal display (LCD), an organic light emitting device (OLED), or any other equivalents. Particularly, the display unit 151 may output a message indicating that the touch lock function is set in the locked or unlocked state. For instance, if the touch lock function is set in the locked state, the display unit 151 may launch a pop-up window displaying a given phrase such as “Touch interface is locked” or “Device is locked” for a given time. Similarly, if the touch lock function is set to the unlocked state, the display unit 151 may launch a pop-up window displaying a given phrase such as “Touch interface is unlocked” or “Device is unlocked” for a given time.

The touch panel 153 detects any contact with the surface of the touch screen 150 by an object such as a user's finger or a touch pen (or stylus pen). Normally the touch panel 153 may be composed of well known touch-sensitive sensors of capacitive overlay type, resistive overlay type, infrared beam type or the like, or alternatively may be formed of pressure sensors. These sensors are for illustrative purposes only and are not to be considered as a limitation of the present invention. Any other types of sensors capable of detecting the contact or pressure of an object may also be used for the touch panel 153. Meanwhile, the touch panel 153 may be disposed on the front of the display unit 151. The touch panel 153 detects a user's touch interaction, generates a touch event based on the detection, and transmits a signal caused by the touch event to the control unit 110. The touch event signal may contain information about a touch location.

The audio processing unit 170 may include a codec which may be composed of a data codec for processing packet data and an audio codec for processing audio signals. The audio processing unit 170 converts digital audio signals into analog audio signals through the audio codec and then outputs them through a speaker (SPK). Also, the audio processing unit 170 converts analog audio signals received from a microphone (MIC) into digital audio signals through the audio codec. Particularly, the audio processing unit 170 may output alert sounds as soon as the touch lock function of the mobile device 100 is set in the locked or unlocked state. Depending on a user's setting, such alert sounds may be suspended.

The memory unit 190 stores a variety of programs and data required for the operation of the mobile device 100. The memory unit 190 may be divided into a program region and a data region. The program region may store an operating system (OS) for booting and operating the mobile device 100, and applications required for various options of the device, such as a web browser for surfing on the Internet, MP3 applications for playing digital sounds, image viewer applications for showing image files, video player applications, game applications, and so forth. Particularly, the program region may store a list of applications currently activated in the mobile device 100.

The data region stores data created while any application is activated. Particularly, the data region may store information about setting states of the mobile device 100 in connection with the touch lock function. Namely, when changing the touch lock function from the locked state to the unlocked state, and vice versa, the control unit 110 may store the current setting state of the touch lock function in the data region. Additionally, the data region may store screen view data to be displayed on the display unit 151. When new or modified screen view data is generated or received according to operations of the mobile device 100, the control unit 110 may store such data as update data in the data region. Thereafter, such data may be selectively retrieved from the data region and then displayed on the display unit 151.

The control unit 110 not only controls electric power supplied for each element, but also performs a general control function for operations of the mobile device 100. Additionally, the control unit 110 may control the flow of signals among the above-discussed elements of the mobile device 100, namely the motion sensor unit 130, the display unit 151, the touch panel 153, the audio processing unit 170, and the memory unit 190.

Particularly, the control unit 110 may recognize motions of the mobile device 100, depending on the sensing signal received from the motion sensor unit 130. The control unit 110 may set the touch lock function in the locked or unlocked state in response to the recognized motion. When receiving the sensing signal from the motion sensor unit 130, the control unit 110 may disregard the received sensing signal if it is smaller than a given threshold level in order to prevent unintended motions of the mobile device 100 from affecting the touch lock function. For instance, if a user moves with the mobile device 100 in his hands or pocket, or if the mobile device 100 is unexpectedly touched by another object, the motion sensor unit 130 may create and send a sensing signal below a given threshold level. In this situation, the control unit 110 determines that the received signal is not caused by a user's manipulation.

The control unit 110 may ascertain the current setting state of the touch lock function by retrieving related information from the data region of the memory unit 190. In addition, as mentioned above, the control unit 110 may set the touch lock function to the locked or unlocked state, depending on the sensing signal of the motion sensor unit 130. Specifically, if the motion sensor unit 130 detects motions of the mobile device 100 while in the unlocked state, the control unit 110 may set the touch lock function to the locked state. While in the locked state, the control unit 110 may not perform a prearranged operation even though a touch event is generated on the touch panel 153. However, if the motion sensor unit 130 detects motions of the mobile device 100 while in the locked state, the control unit 110 may start a timer 111 and then determine whether any touch event is generated on the touch panel 153 within a given time. If there is no touch event within a given time, the control unit 110 may reset the timer 111 and also maintain the locked state. Otherwise, if there is any touch event within a given time, the control unit 110 may reset the timer 111 and also set the touch lock function to the unlocked state. Then the control unit 110 may perform a prearranged operation in response to any touch event. As discussed, the control unit 110 may have the timer 111 therein.

The timer 111 begins to operate as soon as the motion sensor unit 130 detects motions of the mobile device 100 while in the locked state. The operation of the timer 111 continues for a given time. This time may be fixed as default or adjusted according to a user's setting. If a given time passes, or if any touch event is generated on the touch panel 153 within a given time, the timer 111 may stop operating and be reset.

Meanwhile, when the state of the touch lock function is changed, the control unit 110 may control the display unit 151 to display a message indicating such a change. For instance, if the touch lock function is set to the locked state, the control unit 110 may control the display unit 151 to launch a pop-up window displaying a given phrase such as “Touch interface is locked” or “Device is locked” for a given time. After a given time passes, the control unit 110 may stop supplying electric power for the display unit 151 and thereby reduce power consumption of the mobile device 100. Alternatively, if the touch lock function is set to the unlocked state, the control unit 110 may control the display unit 151 to launch a pop-up window displaying a given phrase such as “Touch interface is unlocked” or “Device is unlocked” for a given time.

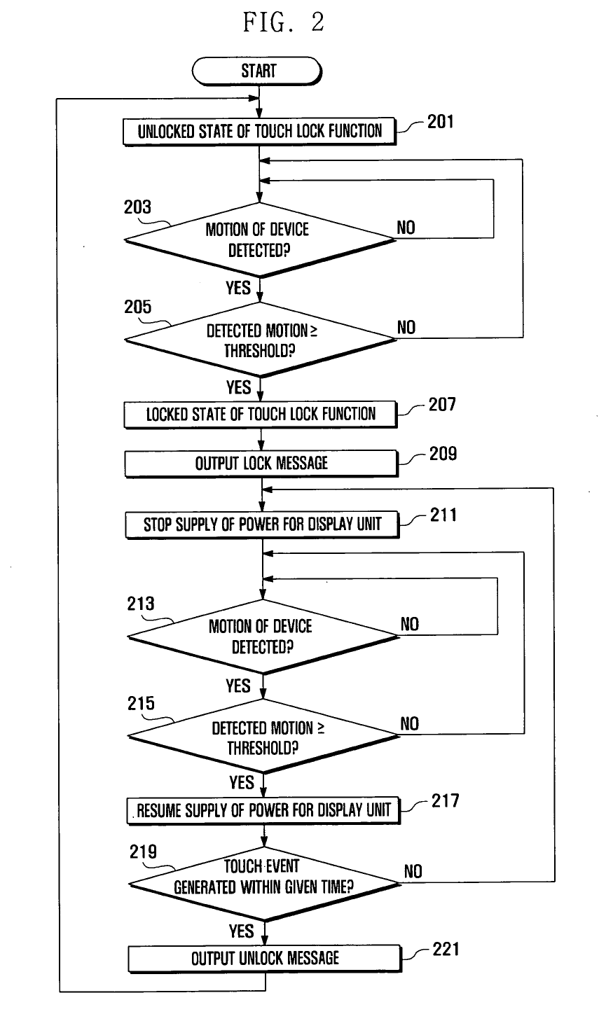

Heretofore, the mobile device 100 that includes the motion sensor unit 130 has been described with reference to FIG. 1. Now, a method for controlling the touch lock function of the mobile device 100 will be described with reference to FIG. 2.

FIG. 2 illustrates a process for controlling a touch lock function in a mobile device in accordance with an embodiment of the present invention.

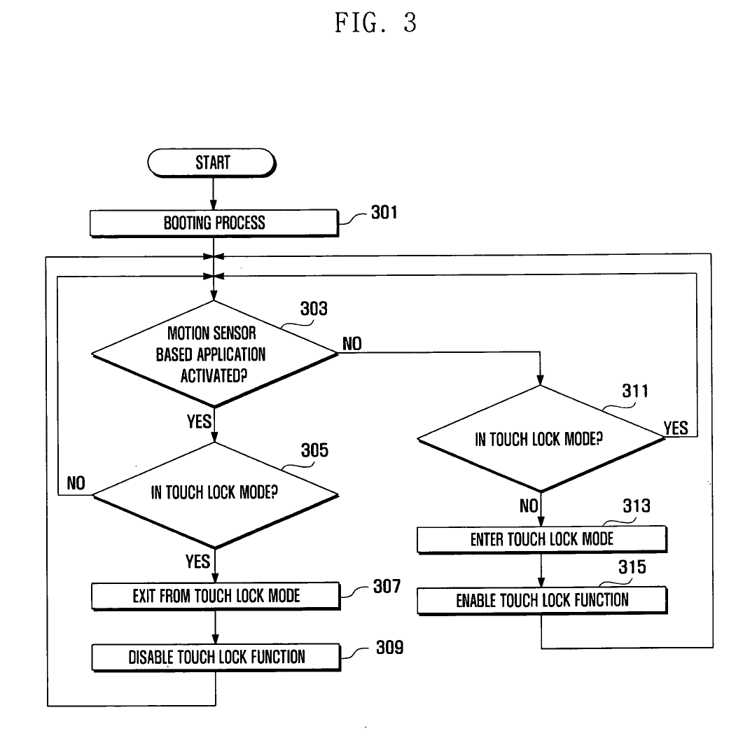

As mentioned above, the touch lock function refers to a function by which a particular operation assigned to a specific touch event may not be performed even though such a touch event is generated. Namely, when the touch lock function is set to the locked state, the control unit 110 does not perform a prearranged operation in response to a touch event. In contrast, if the touch lock function is set to the unlocked state, the control unit 110 performs a prearranged operation in response to a touch event generated on the touch panel 153. Meanwhile, the touch lock function can be performed only while the mobile device 100 is in the touch lock mode. The touch lock mode will be described later with reference to FIG. 3.

Referring to FIGS. 1 and 2, the control unit 110 initially sets the touch lock function of the mobile device 100 to the unlocked state (block 201). In the unlocked state, the control unit 110 may perform a particular operation corresponding to any touch event generated on the touch panel 153.

In block 203, the control unit 110 determines whether any motion of the mobile device 100 is detected, depending on the sensing signal received from the motion sensor unit 130. This continues until any motion is detected through the received sensing signal.

If the motion of the mobile device 100 is detected, the control unit 110 determines whether the magnitude of the detected motion is greater than or equal to a given threshold level (block 205). If the magnitude of the detected motion is smaller than a given threshold level, the control unit 110 disregards the detected motion and continues to detect other motion of the mobile device 100 in the aforesaid block 203. Here, a given threshold level refers to a specific value predefined as the magnitude of the motion usually detected by the motion sensor unit 130 when a user intentionally shakes the mobile device 100 to input any instructions. For instance, if a user moves with the mobile device 100 in his hands or pocket, or if the mobile device 100 is unexpectedly touched with other object, the motion sensor unit 130 may detect the motion below a given threshold level. The control unit 110 interprets the detected motion to not be caused by a user's intentional manipulation and, thus, disregards the detected motion.

If the magnitude of the detected motion is greater than or equal to a given threshold level, the control unit 110 sets the touch lock function of the mobile device 100 to the locked state (block 207). In the locked state, the control unit 110 does not perform a particular operation corresponding to any touch event generated on the touch panel 153.

In block 209, the control unit 110 may control the display unit 151 to output, for a given time, a message indicating that the touch lock function is set to the locked state. For instance, the control unit 110 may control the display unit 151 to launch a pop-up window displaying a given phrase such as “Touch interface is locked” or “Device is locked”. Block 209 may be suspended according to setting conditions of the mobile device 100.

In block 211, the control unit 110 reduces or stops the supply of electric power for the display unit 151. This may contribute to reduction in power consumption of the mobile device 100. Additionally, the control unit 110 may stop the update of screen view data stored in the memory unit 190 such that power consumption of the mobile device 100 may be further reduced.

In block 213, the control unit 110 determines again whether any motion of the mobile device 100 is detected, depending on the sensing signal received from the motion sensor unit 130. This continues until any motion is detected through the received sensing signal.

If the motion of the mobile device 100 is detected, the control unit 110 determines whether the magnitude of the detected motion is greater than or equal to a given threshold level (block 215). If the magnitude of the detected motion is smaller than a given threshold level, the control unit 110 disregards the detected motion and then continues to detect other motion of the mobile device 100 in the aforesaid block 213.

If the magnitude of the detected motion is greater than or equal to a given threshold level, the control unit 110 resumes the supply of electric power for the display unit 151 such that the display unit 151 may display any screen view according to normal operations of the mobile device 100 (block 217). The control unit 110 may also resume the update of screen view data stored in the memory unit 190.

In block 219, the control unit 110 determines whether any touch event is generated on the touch panel 153 within a given time. Although the touch lock function is still in the locked state, the control unit 110 interprets the generated touch event as instructions for setting the touch lock function to the unlocked state. The control unit 110 may start the timer 111 to measure a given time, which may be fixed as default or adjusted according to a user's setting. If no touch event is generated within a given time, the control unit 110 stops and resets the timer 111 and returns to the aforesaid block 211 to reduce or stop the supply of electric power for the display unit 151.

Alternatively, if a touch event is generated on the touch panel 153 within a given time, the control unit 110 initializes the timer 111 and then may control the display unit 151 to output, for a given time, a message indicating that the touch lock function is set to the unlocked state (block 211). For instance, the control unit 110 may control the display unit 151 to launch a pop-up window displaying a given phrase such as “Touch interface is unlocked” or “Device is unlocked”. Thereafter, the control unit 110 returns to block 201 and repeats the above-discussed process.

FIG. 3 illustrates a process for controlling a touch lock mode in a mobile device in accordance with an embodiment of the present invention.

As mentioned above, the touch lock mode refers to a specific mode of the mobile device 100 in which the touch lock function is performed. When the mobile device 100 enters the touch lock mode, the control unit 110 enables the touch lock function. In contrast, when the mobile device 100 exits from the touch lock mode, the control unit 110 disables the touch lock function. Since the touch lock mode allows the touch lock function to be disabled during the activation of any application based on the motion sensor unit 130, a user's shaking gestures for controlling the activated application may not affect the touch lock function.

Referring to FIGS. 1 and 3, the control unit 110 initially performs a booting process (block 301). Specifically, when the power is turned on, the control unit 110 starts an operating system (OS) and initializes the respective elements of the mobile device 100. In addition, the control unit 110 activates selected applications necessary for essential or optional functions of the mobile device 100 and controls the display unit 151 to display a predefined idle screen. Also, the control unit 110 may control the memory unit 190 to store a list of currently activated applications in the program region.

In block 303, the control unit 110 determines whether a specific application, such as a game application or an image edit application, based on the motion sensor unit 130 is activated. Namely, the control unit 110 retrieves applications based on the motion sensor unit 130 from a list of activated applications stored in the memory unit 190.

If any application based on the motion sensor unit 130 is activated, the control unit 110 further determines whether the mobile device 100 is in the touch lock mode (block 305). If the mobile device 100 is not in the touch lock mode, the control unit 110 returns to block 303 and continues to monitor the activation of applications based on the motion sensor unit 130. However, if the mobile device 100 is in the touch lock mode, the control unit 110 exits from the touch lock mode (block 307).

In block 309, the control unit 110 disables the touch lock function of the mobile device 100. Therefore, although a motion of the mobile device 100 is detected in the unlocked state of the touch lock function, the control unit 110 does not change the unlocked state to the locked state. Namely, if the touch lock mode is disabled, the touch lock function is always kept in the unlocked state regardless of motions of the mobile device 100. So, when any application based on the motion sensor unit 130 is activated, a user's actions for controlling the activated application may not affect the touch lock function. Thereafter, the control unit 110 returns to the aforesaid block 303.

Meanwhile, if it is determined in the aforesaid block 303 that an application that utilizes the motion sensor unit 130 is not activated, the control unit 110 further determines whether the mobile device 100 is in the touch lock mode (block 311). If the mobile device 100 is in the touch lock mode, the control unit 110 returns to block 303 and continues to monitor the activation of applications based on the motion sensor unit 130. However, if the mobile device 100 is not in the touch lock mode, the control unit 110 enters the touch lock mode (block 313).

In block 315, the control unit 110 enables the touch lock function of the mobile device 100. With the touch lock function enabled, the mobile device 100 may or may not perform a particular operation assigned to a specific touch event, depending on the setting state of the touch lock function. Thereafter, the control unit 110 returns to the aforesaid block 303.

As fully discussed hereinbefore, the mobile device 100 that includes the motion sensor unit 130 and related method according to the present invention may allow a user to easily change the locked or unlocked state of the touch lock function through a simple action to shake the mobile device. Therefore, the mobile device and method of this invention may not require a user's inconvenient action to press a touch lock or hold key in order to set or modify the state of the touch lock function. This may enhance usability by reducing the use of buttons and also make the mobile device much smaller and thinner by removing a space for a touch lock or hold key.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A mobile device comprising:
a motion sensor unit configured to detect motion of the mobile device and create a sensing signal corresponding to the motion;
a touch panel configured to generate a touch event in response to a user's touch action; and
a control unit configured to set a touch lock function to one of a locked state and an unlocked state, based on the sensing signal of the motion sensor unit, wherein during the locked state of the touch lock function, the control unit does not perform a particular operation assigned to the touch event even though the touch event is generated on the touch panel.

2. The mobile device of claim 1, wherein the control unit comprises a timer configured to measure a given time while in the locked state of the touch lock function when the motion sensor unit detects motion of the mobile device.

3. The mobile device of claim 1, wherein the control unit is further configured to stop supplying electric power to a display unit while in the locked state of the touch lock function.

4. The mobile device of claim 1, wherein the control unit is further configured to exit from a touch lock mode when an application based on the motion sensor unit is activated, wherein exiting from the touch lock mode disables the touch lock function.

5. The mobile device of claim 4, wherein the control unit is further configured to enter the touch lock mode when an application based on the motion sensor unit is not activated, wherein entering the touch lock mode enables the touch lock function.

6. The mobile device of claim 1, further comprising:
an audio processing unit configured to output alert sounds when the touch lock function is toggled between the locked and the unlocked state.

7. The mobile device of claim 2, wherein the control unit is further configured to:
set the touch lock function to the locked state when the sensing signal is received from the motion sensor unit while in the unlocked state of the touch lock function;
set the touch lock function to the unlocked state when a touch event is generated within the given time after the sensing signal is received from the motion sensor unit while in the locked state of the touch lock function; and
maintain the touch lock function in the locked state when the touch event is not generated within the given time after the sensing signal is received from the motion sensor unit while in the locked state of the touch lock function.

8. The mobile device of claim 7, wherein the control unit toggles the touch lock function from the unlocked state to the locked state when the sensing signal received from the motion sensor unit is greater than a threshold.

9. The mobile device of claim 7, wherein the timer starts to measure the given time while in the locked state of the touch lock function when the sensing signal received from the motion sensor unit is greater than a threshold.

10. The mobile device of claim 7, wherein the control unit resets the timer when the touch lock function is toggled from the locked state to the unlocked state.

11. A method for controlling a touch lock function in a mobile device, the method comprising:
creating a sensing signal corresponding to a motion of the mobile device by a motion sensor unit; and
setting the touch lock function to one of a locked state and an unlocked state, depending on the sensing signal received from the motion sensor unit,
wherein during the locked state of the touch lock function, a particular operation assigned to a touch event is not performed even though the touch event is generated on a touch panel.

12. The method of claim 11, wherein setting the touch lock function includes:
setting the touch lock function to the locked state when the sensing signal is received from the motion sensor unit while in the unlocked state of the touch lock function;
setting the touch lock function to the unlocked state when the touch event is generated within a given time after the sensing signal is received from the motion sensor unit while in the locked state of the touch lock function; and
maintaining the touch lock function in the locked state when the touch event is not generated within the given time after the sensing signal is received from the motion sensor unit while in the locked state of the touch lock function.

13. The method of claim 11, further comprising:
stopping the supply of electric power for a display unit while in the locked state of the touch lock function.

14. The method of claim 11, further comprising:
supplying electric power for a display unit when the sensing signal is received from the motion sensor unit in the locked state of the touch lock function; and
stopping the supply of electric power for the display unit when the touch event is not generated within a given time after the sensing signal is received from the motion sensor unit.

15. The method of claim 11, further comprising:
determining whether an activated application utilizes the motion sensor unit;
if the activated application utilizes the motion sensor unit, exiting from a touch lock mode, wherein exiting the touch lock mode disables the touch lock function.

16. The method of claim 15, further comprising:
if none of the activated applications utilize the motion sensor unit, entering the touch lock mode, wherein entering the touch lock mode enables the touch lock function.

17. The method of claim 16, further comprising:
if the touch lock function is enabled, changing the state of the touch lock function based on the sensing signal received from the motion sensor unit; and
if the touch lock function is disabled, maintaining the unlocked state of the touch lock function.

18. The method of claim 11, further comprising:
outputting alert sounds when the touch lock function is toggled between the locked and the unlocked state.

19. The method of claim 12, wherein the touch lock function is toggled from the unlocked state to the locked state when the sensing signal received from the motion sensor unit is greater than a threshold.

20. The mobile device of claim 12, wherein the given time is measured while in the locked state of the touch lock function when the sensing signal received from the motion sensor unit is greater than a threshold.
